(19) United States
(12) Patent Application Publication
(10) Pub. No.: US 2006/0159124 A1
(43) Pub. Date: Jul. 20, 2006

(54) Access control of a multimedia session according to network resources availability

(75) Inventors: Alain Henry, Tregastel (FR); Gilles Lecorgne, Lannion (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 10/563,952

(22) PCT Filed: May 10, 2004
(86) PCT No.: PCT/FR04/50186

§ 371 Date: Jan. 6, 2006

(30) Foreign Application Priority Data
Jul. 21, 2003 (FR) 0350460

(51) Int. Cl. H04J 3/22

(52) U.S. Cl. 370/468

(57) ABSTRACT

A method of access control of a multimedia session between a terminal A and a terminal B connected to a telecommunication network wherein, prior to session set-up, the terminal A transmits to the terminal B a message containing a list of codecs to be used to encode the information to be exchanged during the session to be set up, and at the end of a session, the terminal A transmits to the terminal B a request to close the session. The method intercepts the message containing the list of codecs, modifies the list of codecs proposed by the intercepted message to take into account actual bandwidth resources available for the link between the terminals, transmits to the terminal B the message containing the modified list of codecs, and reserves the resources and updates the database for using access resources.

### TECHNICAL FIELD

The invention lies in the field of telecommunications and more specifically relates to a method of access control of a multimedia session between a terminal A and a terminal B connected to a telecommunication network wherein, prior to session set-up, the terminal A (respectively B) transmits to the terminal B (respectively A) a message containing a list of codecs for encoding data to be exchanged during the session to be set up, and at the end of a session, the terminal A (respectively B) transmits to the terminal B (respectively A) a request to close the session.

The method namely applies to private or public IP (“Internet Protocol”) networks.

### PRIOR ART STATEMENT

When a request to open a session is sent by a calling entity of a network, referred to as the originating entity, the latter sends messages containing information on all of the “codecs” (i.e. on data “Compression/Decompression” procedures for the transmissions on the network) proposed to set up a multimedia session with a called entity of the network, referred to as the destination entity. For each type of flow (audio, video etc.), the originating entity that wishes to set up a session proposes one or several codecs to the destination entity. A data transmission rate on the network corresponds to each codec depending on the current transfer mode on this network (the ATM transfer mode for example). Other protocols can be used specifically for the reservation of bandwidth, the RSVP protocol (“resource reservation protocol”) for example.

The bandwidth control mechanisms recommended by the current standards for the set-up of a session between two terminals in a packet transmission network are based on the negotiation of the multimedia information encoding systems (audio, video codecs) directly between these terminals by means of the signalling protocols such as the protocols SIP or H323 for example. The request for bandwidth is sent directly from the terminals and is carried by these signalling messages.

Many known industrial products, grouped under the generic term SBC (“Session Border Controller”), offer multimedia session access control solutions wherein the originating terminal transmits a request containing codec propositions for setting up a session to the destination terminal, the destination terminal then answers by accepting one or several of the proposed codecs according to the types of data to be transmitted during the session and calculate a bandwidth according to the codecs accepted and the transport capacities peculiar to the input/output interfaces between the access network and the rest of the network.

A disadvantage of these devices stems from the fact that the session access control can only guarantee the absence of saturation of the interfaces during the sessions but not that of the access link.

In addition, these systems do not allow for the reservation of bandwidth resources, when a session is set up, that take into account the network (or the access network) resources, namely on the link under consideration between the originating point and the destination point. This is detrimental to optimum network management in terms of bandwidth.

Another drawback of the prior art relating to this resource control method stems from the fact that it is not possible to guarantee a quality of service on a given link adapted to support several sessions. This particularly penalises telephone operators, for example, for which it is important to be able to guarantee certain quality of service (or “QoS”) parameters,

### REPORT ON THE INVENTION

The invention recommends an access control mechanism for a session between a first terminal A located at an originating point and a second terminal B located at a destination point in a telecommunication network, that dynamically considers, not only the codecs proposed by the terminal A and accepted by the terminal B but also the actual bandwidth resources available on this link.

These objects are archived by a method wherein, prior to session setting up, the terminal A (respectively B) transmits to the terminal B (respectively A) a message containing a list of codecs for encoding data to be exchanged during the session to be set up, and at the end of a session, the terminal A (respectively B) transmits to the terminal B (respectively A) a request to close the session.

The method according to the invention comprises the following steps:
intercepting the message containing the list of codecs,
modifying the list of codecs proposed by the intercepted message in order to take into account the actual bandwidth resources available for the link between the terminal A and the terminal B, and
transmitting to the terminal B (respectively A), the message containing the modified list of codecs,
reserving the resources and updating the database for using access resources.

The telecommunication operators can hence control the resource shared between several users of a network and avoid saturation of the network access links.

In addition, this method comprises the following steps in the event that terminal B (respectively A) should accept the request to set up a session,
setting up the session between the terminal A and the terminal B using the modified codecs,
calculating the residual bandwidth resources according to the bandwidth resources corresponding to the accepted codecs,
memorising the value of the residual resources calculated during the previous step in a database for using access resources,

filtering the media flows according to a request for bandwidth resources,

authorising the flow transmission between the terminal A and the terminal B according to the bandwidth resources corresponding to the accepted codecs,

and in the event of session refusal,

transmitting to the terminal A (respectively B) a message indicating the failure of session set-up,
updating said database according to the bandwidth resources released on the link.

Note that in an IP context, the media flows are identified by means of the IP addresses and the UDP ports implicated.

Owing to the method according to the invention, the transmission of information following the set-up of the session between the terminal A and the terminal B is carried out according to recommended rates accepted by both the terminal A and the terminal B and compatible with the actual transmission capacity of the link between the terminal A and the terminal B.

In the event of a request to close the multimedia session sent by the terminal A (respectively B), the method according to the invention comprises the following steps:
intercepting the request to close the session sent by the terminal A (respectively B),
identifying the open session for which the request to close has been sent,
determining the codecs used during said session,
transmitting the request intercepted to the terminal B (respectively A),
blocking the transmission between the terminal A and the terminal B;
calculating the values of the residual bandwidth resources according to the resources released on the link between the terminal A and the terminal B by stopping the session, and
updating the database for using network access resources, with the residual carrying capacity values calculated during the previous step.

In a particular application of the method according to the invention, the telecommunication network is a packet data transfer network and the message containing the list of codecs exchanged between the terminal A and the terminal B is transmitted via one of the signalling protocols SIP or H323.

The invention also relates to an access control device for a multimedia session between a terminal A and a terminal B connected to a telecommunication network wherein, prior to session set-up, the terminal A (respectively B) transmits to terminal B (respectively A) a message containing a list of codecs to be exchanged during the session to be set up, and at the end of a session, the terminal A (respectively B) transmits to the terminal B a request to close the session.

The device according to the invention comprises means of intercepting the message containing the list of codecs and means of modifying the list of codecs proposed in the intercepted message in order to take into account the actual bandwidth resources available for the link between the terminal A and the terminal B.

In a particular embodiment, the device comprises:
a filtering module FM intended to intercept the signalling flows from the terminal A (respectively B);
a call module CM intended to extract the codecs proposed in the signalling messages,
a session access module SAM intended to generate a new request to set up a session with a list of codecs of which the carrying capacities are compatible with the bandwidth resources available for the link between the terminal A and the terminal B, and
a database DB containing the value of the bandwidth resources available for the link between the terminal A and the terminal B.

Note that the role of the terminals A and B may be exchanged without modifying the method according to the invention. The terminal B may indeed be the originating point of the request for session set-up and the terminal A the destination point of this request. In all instances, the destination entity of the request for session set-up or closing as well as the originating entity of this request are termination points of the signalling protocol (in the signalling data that indicate the originating point and the destination point) that correspond to the originating point of the messages exchanged.

### BRIEF DESCRIPTION OF THE DRAWINGS

Other characteristics and advantages of the invention will emerge from the description that follows, by way of a non-limitative example, with reference to the accompanying drawings wherein:

FIG. 1 schematically shows a device to implement the method according to the invention,

FIG. 2 is a flow chart illustrating the method according to the invention in the case of transmission of a request to set up a session by a terminal,

FIG. 3 is a flow chart illustrating the method according to the invention in the case of transmission of a session closing request by a terminal,

### DETAILED DESCRIPTION OF THE PARTICULAR EMBODIMENTS

The description that follows relates to a particular application of the method in an IP network.

Note that the signalling protocols used in IP networks to enable point-to-point or multi-point conferences (audio and video) between a terminal A and a terminal B are:
the protocol H323 that is a standard relating to multimedia conferences on packet transmission networks (including IP transfers) recommended by the ITU (International Telecommunication Union), based on the RTP/RTCP (“Real time Transfer Protocol/Real time Transfer Control Protocol”)communication protocols defined by the IETF (Internet Engineering Task Force) and also on audio codecs (for example: G.711, G.723.1, G.728, . . . ) and video codecs (for example: H261 and H.263). H323 documentation is available on the ITU website: www.itu.int/ITUT/publications/recs.html, H series.
The SIP protocol “Session Initialisation Protocol” created to replace the protocols defined in the H323 standard, is a signalling protocol for telephony and videoconferencing used for transmissions in real-time. This protocol is based on http and MIME (Multipurpose Internet Mail Extensions) and is based on the SDP protocol (“Session Description Protocol” [RFC2327]) for session descriptions and on RTP (“Real Time Protocol”) for data transport.

Use of the SDP protocol in the SIP messages is described in appendix B of RFC2543 (the RFC references are available on the IETF website http://www.ietf.org/rfc).

In the following part of the description it will be assumed that the terminals A and B are connected in ATM mode via an access link to the IP network and have a virtual channel within a virtual port on this link.

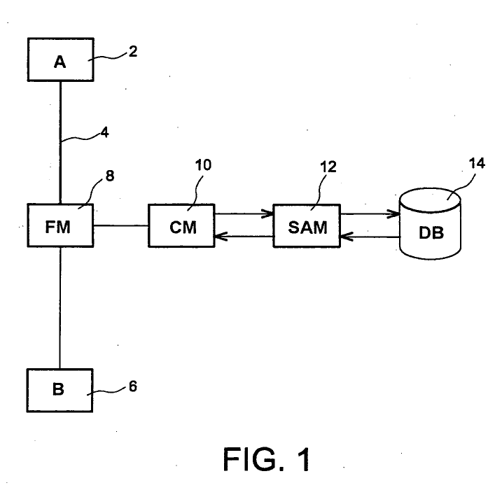

FIG. 1 schematically illustrates a device intended to implement the method according to the invention shown in which are the terminal A with the reference 2, the access link 4 of terminal A, the terminal B with the reference 6, a media flow filtering module FM adapted to filter on filtering request, received by a call module CM, the media flows relative to a session identified on the link between the terminal A and the entity B, according to the rate recommendations indicated in the filtering request, and adapted to block upon blocking request, received from the CM module, the media flows relative to a session identified on this link; the CM module being adapted to intercept and route to the CM module the signalling flows from the terminal A as well as the signalling flows from the terminal B; a call module CM 10 intended to extract the codecs proposed in the signalling messages, a session access module SAM 12 intended to generate a request to set up a session with a list of codecs of which the carrying capacities are compatible with the bandwidth resources available for the link between the terminal A and the terminal B, and a database DB 14 containing the actual values of the carrying capacities of the virtual channels and ports of the access link of the terminal A (respectively B), and namely the actual values of the available rates DCvc and DCvp, respectively for the virtual channel (VC) and the virtual port (VP) of the terminal A (respectively B) and a signalling flow routing module SFRM adapted to route the signalling flows transmitted between the entity A and the entity B to a call module CM.

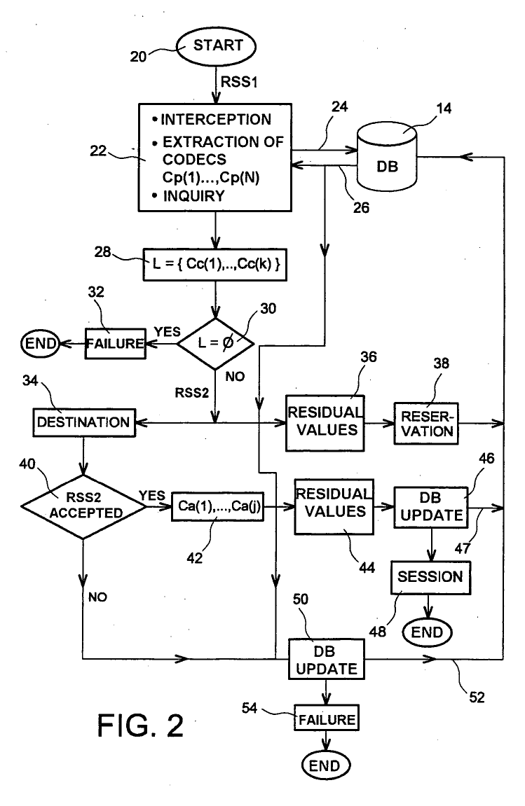

The steps of the method in the event of a request to set-up a session sent by the terminal A will be described with reference to FIG. 2.

During step 20 a request to set up a session RSS1 containing a list of codecs Cp(1), Cp(N) is sent by the terminal A to the access link 4.

During step 22, the RSS1 request is intercepted by the module CM 8 and then directed to the module CM 10. The latter extracts the codecs Cp(1), . . . , Cp(N) proposed and sends (arrow 24) to the database 14 an inquiry message to determine the actual values of the carrying capacities of the virtual channels and ports of the access link of the terminal A, and namely the actual values of the available rates DCvc and DCvp, respectively for the virtual channel (VC) and the virtual port (VP) of the terminal A.

In response to this message, the database 14 provides (arrow 26) the module CM 10 with the requested values. With these values and with the extracted codecs, a list L of the compatible codecs Cc(1), . . . , Cc(K) is determined during step 28. Step 30 consists in checking the compatibility of the codecs on the list established during step 28 against the actual values DCvc and DCvp respectively of the carrying capacities of the virtual channels and ports. This check is carried out as follows:

By referring to the rate corresponding to the codec Cp(i) (i varies between 1 and N) as DCp(i), if DCp(i)<DCvc and if DCp(i)<DCvp, then the codec Cp(i) is compatible and is hence added to the list L. If the list L is empty, a failure message is then transmitted (step 32) to the terminal A.

If, on the contrary, L is not empty, then the compatible codecs Cc(1), . . . , Cc(K) that it contains are inserted into a new request RSS2 that is sent (step 34) to the terminal B.

At the same time, residual carrying capacity values, namely residual rates DRvc and DRvp (respectively for the virtual channel and the virtual port of the terminal A), are calculated during step 36.

By referring to the rate corresponding to the compatible codec Cc(i) (I varies between 1 and K) as DCc(i), the residual rates are obtained as follows:
DRvc=DCvc−Max(DCc(1), . . . , DCc(K))
and
DRvp=DCvp−Max(DCc(1), . . . , DCc(K)).

Step 38 consists in reserving resources corresponding to the values of the carrying capacities of the virtual channels and the virtual ports of the access link of the terminal A.

This reservation of resources is carried out by updating the database 14 with the residual values of the carrying capacities of the virtual channels and the virtual ports of the access link of the terminal A calculated beforehand.

The database 14 is updated by carrying out the following assignment operations:

DCvc=DRvc and DCvp=DRvp.

Step 40 consists in checking whether the terminal B accepts or refuses the new request RSS2.

If the terminal B accepts this new request RSS2, then the accepted codecs Ca(1), . . . , Ca(J) are memorised (step 42). These codecs are then used with the actual values of the carrying capacities of the virtual channels and ports of the access link of the terminal A to calculate the residual values (step 44) as follows:
By referring to the rate corresponding to the accepted codec Ca(i) (i varies between 1 and J) as DCa(i), the residual values are given by means of the following expressions:
   DRvc=DCvc−Max(DCa(1), . . . , DCa(J))
   and
   DRvp=DCvp−Max(DCa(1), . . . , DCa(J))

During step 16, the database DB 14 is updated by the sending (arrow 47) of a message containing the residua values calculated. This update is carried out via the following assignment operations:

DCvc=DRvc and DCvp=DRvp.

During step 48, the session is authorised If during step 40 the request RSS2 is not accepted by the terminal B, then the database DB is updated (step 50) by a message (arrow 52) containing the actual values of the carrying capacities of the virtual channels and ports of the access link of the terminal A to replace the stored values. A failure message is then sent (step 54) to the terminal B.

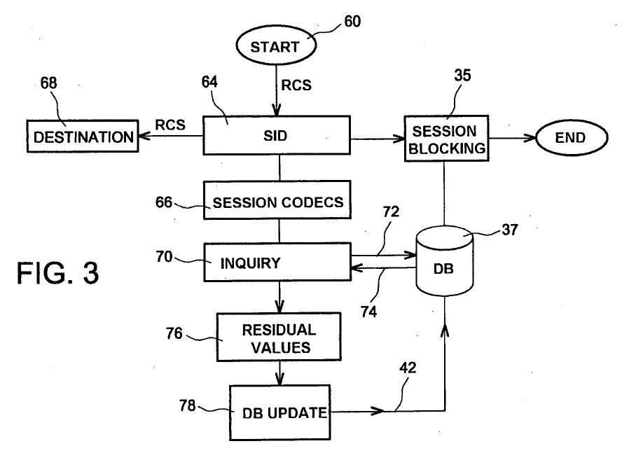

The steps of the method in the event of a request to close the session sent by the terminal A will now be described with reference to FIG. 3.

During step 60, a request to close the session RCS is sent by the terminal A to the access link 4.

During step 62, the module CM 10 extracts from the RCS message the session identifier SID 64, the codecs 66 used for the current session Cs(1), . . . , Cs(P) memorised beforehand during session opening.

A RCS message is then sent to the terminal B (step 68).

During step 70, the module CM 10 sends(arrow 72) to the database 14 an inquiry to obtain the actual values of the carrying capacities of the virtual channels and the virtual ports of the access link of the terminal A.

In response to this inquiry, the database 14 provides (arrow 74) the actual values of the carrying capacities of the terminal A access link, namely the actual rate of the virtual channel of A, DCvc, and that of the virtual channel of A, DCvp.

From these values and values corresponding to the current codecs 66, residual values are calculated (step 76) according to resources released on this link by stopping the session, corresponding to the codecs associated with the noted identifier of the session. By referring to the residual rate of the virtual channel of A as DRvc(i), and that of the virtual port of A as DRvp and the rate corresponding to the codec Cs (i) (i varies between 1 and P) as DCs (i), the residual values are calculated as follows:
DRvc=DCvc+Max(DCs(1), . . . , DCs(P))
and
DRvp=DCvp+Max(DCs(1), . . . , DCs(P)),

The rate value Max(DCs(1), . . . , DCs(P)) is the rate value corresponding to the codecs stored in memory when the session is opened.

The database DB is then updated (step 78) by the sending of a message 42 containing the residual values calculated.

For the rates, the update is carried out via the following assignment operation:

DCvc=DRvc and DCvp=DRvp.

1-7. (canceled)

8. A method of access control of a multimedia session between a terminal A and a terminal B connected to a telecommunication network wherein, prior to a session set-up, the terminal A transmits to the terminal B a message containing a list of codecs for encoding data to be exchanged during the session to be set up, and at an end of the session, the terminal A transmits to the terminal B a request to close the session, the method comprising:
intercepting the message containing the list of codecs;
modifying the list of codecs proposed by the intercepted message to take into account actual bandwidth resources available for a link between the terminal A and the terminal B;
transmitting, to the terminal B, the message containing the modified list of codecs; and
reserving the resources and updating a database for using access resources.

9. A method according to claim 8, further comprising:
in an event that terminal B accepts the request to set up a session:
setting up the session between the terminal A and the terminal B using the modified codecs;
calculating residual bandwidth resources according to the bandwidth resources corresponding to the accepted codecs;
memorizing a value of the residual resources calculated during the calculating in a database for using access resources;
filtering media flows according to a request for bandwidth resources; and
authorizing the flow transmission between the terminal A and the terminal B according to the bandwidth resources corresponding to the accepted codecs;
and in an event of session refusal:
transmitting to the terminal A a message indicating the failure of session set-up; and
updating the database according to the bandwidth resources released on the link.

10. A method according to claim 8, further comprising, at an end of a multimedia session:
intercepting the request to close the session sent by the terminal A;
identifying the current session for which the request to close has been sent;
determining the codecs used during the session;
transmitting the request intercepted to the terminal B;
blocking the transmission between the terminal A and the terminal B;
calculating values of the residual bandwidth resources according to the resources released on the link between the terminal A and the terminal B by stopping the session; and
updating the database for using network access resources, with the residual values of the carrying capacity calculated during the previous calculating.

11. A method according to claim 9, wherein the transmission of information following the set-up of the session between the terminal A and the terminal B is carried out according to recommended rates accepted by both the terminal A and the terminal B and is compatible with actual transmission capacity of the link between the terminal A and the terminal B.

12. A method according to claim 8, wherein the telecommunication network is a packet data transfer network, and the message containing the list of codecs exchanged between the terminal A and the terminal B is transmitted via one of signalling protocols SIP or H323.

13. An access control device for a multimedia session between a terminal A and a terminal B connected to a telecommunication network wherein, prior to a session set-up, the terminal A transmits to the terminal B a message containing a list of codecs for encoding data to be exchanged during the session to be set up, and at an end of the session, the terminal A transmits to the terminal B a request to close the session, the device comprising:
means for intercepting the message containing the list of codecs; and
means for modifying the list of codecs proposed in the intercepted message to take into account actual bandwidth resources available for the link between the terminal A and the terminal B.

14. A device according to claim 13, further comprising:
a media flow filtering module configured to filter on a filtering request, received from a call module, media flows relative to a session identified on the link between the terminal A and the entity B, according to rate recommendations indicated in the filtering request, and configured to block, on a blocking request received from the call module, the media flows relative to a session identified on this link; the filtering module configured to intercept and to route to the call module signalling flows from the terminal A and signalling flows from the terminal B;
the call module CM configured to extract the codecs proposed in the signalling messages;
a session access module configured to generate a new request to set up a session with a list of codecs of which the carrying capacities are compatible with the bandwidth resources available for the link between the terminal A and the terminal B;
a database containing the value of the bandwidth resources available for the link between the terminal A and the terminal B; and
a signalling flow routing module configured to route the signalling flows transmitted between the terminal A and the terminal B to the call module.
